(19) United States
(12) Patent Application Publication
(10) Pub. No.: US 2026/0334221 A1
(43) Pub. Date: Oct. 22, 2026

(54) LOCALIZED STRUCTURAL SURFACE ENHANCEMENT FEATURES FOR POWER ELECTRONIC DEVICE ATTACHES

(71) Applicant: Wolfspeed, Inc., Durham, NC (US)

(72) Inventors: Argirios Papagianis, Fayetteville, AR (US); Bakhtiyar Mohammad Nafis, Springdale, AR (US); Filip Boshkovski, Fayetteville, AR (US); Brice McPherson, Springdale, AR (US)

(21) Appl. No.: 19/182,318

(22) Filed: Apr. 17, 2025

(51) Int. Cl. H10W 40/20; G06F 30/392; G06F 30/398; G06F 113/18; G06F 119/08; H10W 40/00; H10W 40/22

(52) U.S. Cl. CPC H10W 40/235; G06F 30/392; G06F 30/398; H10W 40/037; H10W 40/228; G06F 2113/18; G06F 2119/08

(57) ABSTRACT

A support structure for mounting an element of a semiconductor component according to some embodiments includes a mounting surface for receiving the element of the semiconductor component. The element of the semiconductor component is mountable within a mounting footprint of the mounting surface. The mounting surface includes a surface enhancement feature that is configured to modify a thickness of a metallurgical attach material that is provided between the support structure and the element of the semiconductor component to attach the element of the semiconductor component to the support structure.

### FIELD

The present disclosure relates to semiconductor power devices, and in particular to metallizations for power semiconductor devices.

### BACKGROUND

Power semiconductor modules are semiconductor components that include a power semiconductor device mounted on a substrate. The substrate may be mounted on a submount, heat sink or other metal component to enhance thermal dissipation. There are many components and surfaces that are metallurgically attached in a power module.

In this context, an “attach” refers to a metallurgical attach, including solder, braze, transient liquid phase bonding, sintering, and the like. For example, a semiconductor package substrate may be metallurgically attached to a heat sink to facilitate cooling of the packaged semiconductor device. A heat sink may include a natural convection heat sink, a forced convection heat sink, a liquid cooling heat sink, a heat spreader, a base plate, and the like.

The substrate on which a power semiconductor device is mounted may include a Direct Bond Copper (DBC) substrate, an Active Metal Braze (AMB) substrate or other similar substrate. The substrate may also include a signal substrate, for example, flex tape, printed circuit boards, and the like.

The semiconductor device may include a high voltage, high current transistor device, for example, a metal oxide semiconductor field effect transistor (MOSFET), a junction field effect transistor (JFET), an insulated gate bipolar transistor (IGBT), a bipolar junction transistor (BJT), a diode, or any other similar device.

A power semiconductor device typically includes two or more terminals that receive or supply current, including for example power terminals, power contacts, lead frames, signal terminals, signal contact, signal connector, and the like.

An example of a power module attached to a heat sink is illustrated in cross-section in FIG. 1. As illustrated therein, a power module may include one or more power semiconductor devices (or power devices) mounted on a substrate via a device attach. The substrate and device may be enclosed in a molded package housing or other protective structure, for example, a metal enclosure or an encapsulant material. One or more electrical leads penetrate the housing and are connected to the semiconductor device via leads, traces, or wire bonds (not shown). The module is attached to a heat sink via a package attach, with the substrate contacting the heat sink through the package attach. Both the device attach and the package attach may be metallurgical attaches.

Some elements of the power module, for example, internal interconnections, are not shown in FIG. 1. Note that the type of substrate, package, or power module may vary greatly, with the cross section shown in FIG. 1 being employed to illustrate the package and device attach layers.

The heat sink is typically a metal structure that provides a large surface area for heat dissipation. The heat sink may, as pictured in FIG. 1, have cooling fins integrated into itself or may alternatively be a plate which is then attached to a heat sink or cold plate. Air or coolant may flow through the heatsink, carrying away the absorbed heat.

In many cases, a conventional heat sink is enhanced with features that may enhance heat extraction, for example, pin fins for cooling, bolt holes, threaded holes, and raised pedestals for pressure based attached and in some cases for additional voltage isolation. Example heat sink configurations that are typical in power electronic components are depicted in FIG. 2. Heat sinks may be flat surfaces or, often, have a curvature introduced such that there is a convex surface to account for thermal deflection during the attach process.

In power modules, a substrate is typically attached to a heat sink as shown in FIG. 1. The substrate may be a separate part, or one that has previously been integrated into another assembly, such as in the case of an overmolded power module. A simplified power substrate, shown in FIG. 3, comprises metal traces bonded to one or both sides of a dielectric isolation layer. Substrate traces can be patterned to form a circuit topology or left as a large field to function as a thermal pad. Substrates may be multiple functional layers of traces, isolation, and thermal surfaces. Typically, thermal surfaces of substrates are what is attached to a heat sink.

As noted above, power devices are generally attached to the substrate. In power electronics, devices are typically vertical devices that have active functional surfaces on the topside and the backside thereof. A typical power device, in this case a MOSFET, is depicted in FIG. 4 for example. As shown in FIG. 4, a power MOSFET device includes a semiconductor chip 10 having a top side 10A and a back side 10B. Source pads 12 are provided on the top side 10A along with a gate pad 14. A drain pad 16 is formed on the back side 10B of the semiconductor chip. The top side pads, i.e., the source pads 12 and gate pad 14, may be configured to receive a wire bond contact, while the back side drain pad 16 may be configured to be attached to an underlying substrate or a terminal.

Pad sizes, geometries, and locations vary depending on device size and the desired interconnection method. Generally speaking, the backside pad is used as the primary thermal surface for heat removal and is attached to the substrate or directly to a terminal. Topside pads may be wire or ribbon bonded to, or also attached to a substrate or directly to a terminal.

Attaching metal surfaces together is generally accomplished with a metallurgical attach. The attach material (which may be provided as preforms, paste and the like) is applied, then the mating components or assembly (power modules, substrates, terminals, MOSFETs, heat sinks and the like) are assembled to mate with the attach material. In the case of solder or braze reflow, the assembly is then inserted into a reflow oven, where it is heated to temperatures in which the attach material changes phase from solid to liquidous. In the liquidous phase, the material spreads to evenly coat both the faying (i.e., mating) surfaces. When the assembly is cooled, the attach material solidifies, creating a bond between the power module and the heat sink. Other forms of attach, for example, transient liquid phase or sintering, utilize similar process steps with the addition of pressure, and may induce similar stresses in the attach layers as the assembly cools.

### SUMMARY

A semiconductor component according to some embodiments includes a support structure, an element of the semiconductor component on the support structure, and a metallurgical attach material that attaches the element of the semiconductor component to the support structure. The support structure includes a mounting surface for receiving the element of the semiconductor component, and the element of the semiconductor component is mountable within a mounting region of the mounting surface. The mounting surface includes a surface enhancement feature that is configured to modify a thickness of the metallurgical attach material that is provided in or near the mounting region between the support structure and the element of the semiconductor component to attach the element of the semiconductor component to the support structure.

The surface enhancement feature may be a three-dimensional feature such as a trench, a protrusion or ridge, a hole or a trench.

In some embodiments, a thickness of the attach material is greater near corners of the mounted element than away from corners of the mounted element.

The surface enhancement feature may be provided within a mounting footprint of the mounted element.

In some embodiments, the surface enhancement feature overlaps an edge of a mounting footprint of the mounted element and/or the surface enhancement feature may be provided outside a mounting footprint of the mounted element.

The surface enhancement feature may be provided near corners of a mounting footprint of the mounted element.

The surface enhancement feature may form a complete shape on the mounting surface or a partial shape on the mounting surface.

The surface enhancement feature may form a polygonal, elliptical or circular shape on the mounting surface, or forms a pattern of linear features on the mounting surface, or forms a grid, cross-hatch, serpentine, wavy, fill, or random pattern on the mounting surface.

In some embodiments, the surface enhancement feature may be formed near a portion of a mounting footprint of the mounted element where the element of the semiconductor component is expected to experience heightened stress after mounting.

The support structure may include a submount, heatsink, power substrate, and/or a base plate. The element of the semiconductor component includes a semiconductor die, a submount, or a power substrate.

The surface enhancement feature may include multiple surface enhancement features arranged in concentric patterns.

In some embodiments, the element of the structure includes a semiconductor die and the support structure includes a power substrate.

The power substrate may be mounted on an underlying support structure that includes a second mounting surface for receiving the support structure. The support structure may be mountable within a second mounting region of the second mounting surface.

The second mounting surface may include a second surface enhancement feature that is configured to modify a thickness of a second metallurgical attach material that is provided in or near the second mounting region between the underlying support structure and the support structure to attach the support structure to the underlying support structure. The underlying support structure may be a heat sink.

A support structure for mounting an element of a semiconductor component according to some embodiments includes a mounting surface for receiving the element of the semiconductor component, wherein the element of the semiconductor component is mountable within a mounting footprint of the mounting surface. The mounting surface includes a surface enhancement feature that is configured to modify a thickness of a metallurgical attach material that is provided between the support structure and the element of the semiconductor component to attach the element of the semiconductor component to the support structure.

A semiconductor component according to some embodiments includes a metal support element, and a packaged semiconductor device mounted on the metal support element, and a metallurgical attach material between the metal support element and the packaged semiconductor device.

The metal support element includes a surface enhancement feature that modulates a thickness of the metallurgical attach material in or near a mounting region between the metal support element and the packaged semiconductor device.

A packaged semiconductor device according to some embodiments includes a power substrate, a semiconductor die mounted on the power substrate, and a metallurgical die attach material between the power substrate and the semiconductor die. The power substrate includes a surface enhancement feature that modulates a thickness of the metallurgical die attach material in or near a mounting region between the power substrate and the semiconductor die.

A method of manufacturing a semiconductor component includes (a) for a semiconductor component design including a support structure and an element of the semiconductor component mounted on the support structure, generating a first stress pattern representative of stresses experienced by the element of the semiconductor component after being mounted onto the support structure using a metallurgical attach material according to the semiconductor component design, (b) modifying the semiconductor component design to provide a surface enhancement feature on a mounting surface of the support structure on which the element of the semiconductor component is to be mounted, (c) generating a second stress pattern representative of stresses experienced by the element of the semiconductor component after being mounted onto the support structure using a metallurgical attach material according to the modified semiconductor component design, (d) comparing the first stress pattern to the second stress pattern, and (e) implementing the modified semiconductor component design based on the comparison of the first stress pattern and the second stress pattern.

The method may further include repeating steps (b) through (e) until a desired level of stress in the element of the semiconductor component is obtained.

### BRIEF DESCRIPTION OF THE DRAWINGS

FIG. 1 illustrates an example of a power module attached to a heat sink.

FIG. 2 illustrates example heat sink configurations that are typical in power electronic components.

FIG. 3 illustrates a simplified power substrate.

FIG. 4 illustrates a MOSFET device.

FIG. 5 illustrates a back side and top side of a heat sink having a bonding surface that has been according to some embodiments.

FIG. 6 illustrates a back side and top side of a power substrate according to some embodiments.

FIG. 7 illustrates an assembly including a heat sink, power substrate, and power devices.

FIG. 8 illustrates an example cross section of a failed package attach.

FIG. 9 illustrates examples of various package attaches with protrusions and/or trenches provided in the bonding surface of an underlying heat sink.

FIG. 10 illustrates a thermal stress simulation comparing a standard attach to an attach where the bond line is selectively increased according to some embodiments.

FIG. 11 illustrates a conventional heat sink with no surface enhancement features.

FIG. 12 illustrates various examples of surface enhancement feature designs.

FIG. 13 illustrates showing attach bond lines for various locations of a trench feature according to some embodiments.

FIG. 14 illustrates various examples of surface enhancement feature designs.

FIG. 15 illustrates various examples of surface enhancement feature designs.

FIG. 16 illustrates various examples of surface enhancement feature designs.

FIG. 17 illustrates various examples of surface enhancement feature designs.

FIG. 18 illustrates various contoured surfaces between trench and protrusion surface features according to various embodiments.

FIG. 19 is a flowchart that illustrates operations for a method of manufacturing a semiconductor component according to some embodiments.

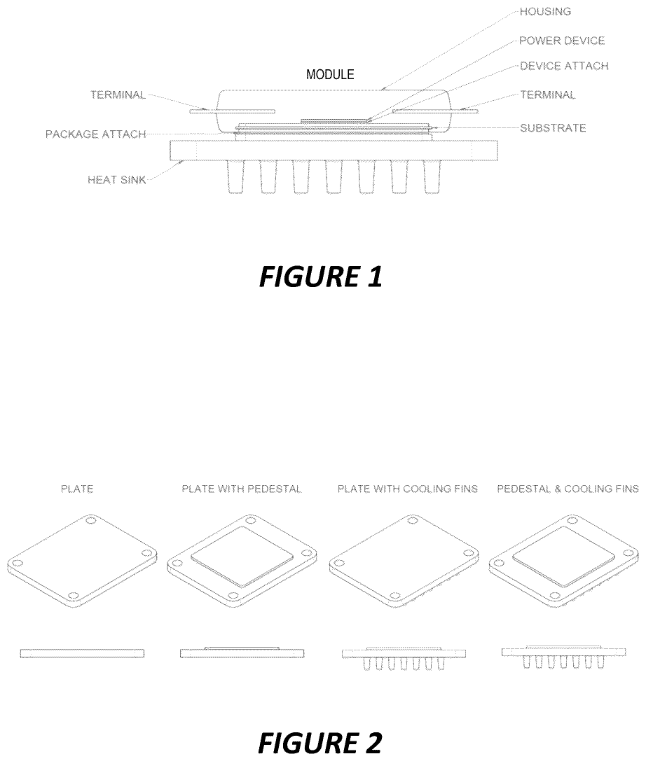

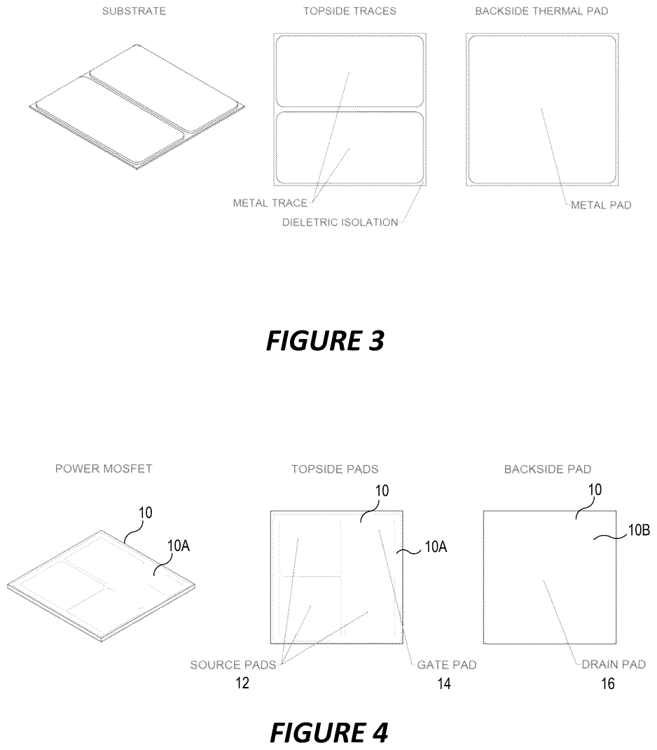

### DETAILED DESCRIPTION

Some embodiments described herein provide structures for enhancing the structural integrity of power substrates, base plates, heat sinks, heat spreaders, terminals, and the like. Enhanced structural integrity may facilitate resilient and robust metallurgical attaches. This is achieved through modifying the bonding surface such that there are sunken and/or raised features to increase the surface area of the metallurgical bond and to function as localized bond line control and mechanical anchors. That is, one or more bonding surfaces may be modified to include trenches (sunken features) and/or protrusions (raised features) that can improve the mechanical integrity of the bond.

As used herein, a “trench” may refer to any debossed, sunken, milled, machined, cut, subtractive feature, and the like, while a “protrusion” may refer to any embossed, raised, extruded, machined, elevated, additive feature and the like.

The features are located selectively in places of high stress so that they may provide localized stress relief based on the unique stress profile of a particular geometry and material composition. Stress relief is realized both through the anchoring effect and a localized increase in bond line thickness, where “bond line” refers to the cross sectional profile of the attach material that is provided between the mating surfaces. In addition, raised features may be implemented which can act to impede or limit the magnitude of crack growth by acting as a hard stop and also serve as a means to control the bond line thickness.

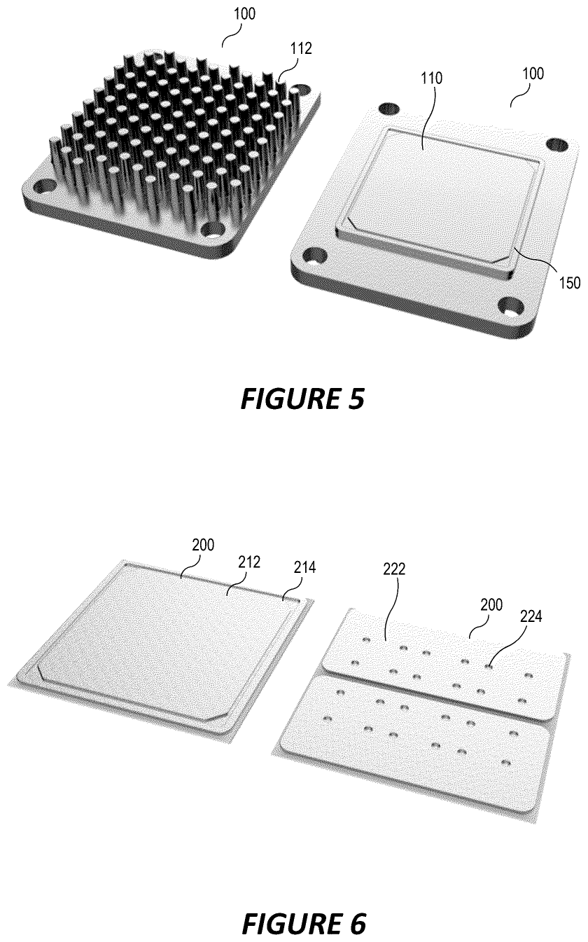

FIG. 5 shows a back side (left) and top side (right) of a heat sink 100 having a bonding surface that has been according to some embodiments. In particular, the heat sink 100 has a bonding surface 110 on the top side thereof on which a power semiconductor package may be mounted. The bonding surface 110 is generally centered on the top side of the heat sink 100, although other configurations are possible.

Heat extraction features, for example, pins (as depicted), fins, pillars, and the like, are provided on the back side of the heat sink 100.

According to some embodiments, a perimeter and corner trench 150 is provided around an outer perimeter of the bonding surface 110. As described in greater detail below, the trench 150 may enhance package attach strength to the heat sink 100.

FIG. 6 shows a back side (left) and top side (right) rendering of a power substrate 200 according to some embodiments. The power substrate 200 has a bonding surface 212 on the back side thereof and a bonding surface 222 on the front side thereof. A surface enhancement feature in the form of a perimeter and corner trench 214 is provided on the back side of the power substrate 200 to enhance package attach strength to a heat sink. Circular holes 224 are provided in the bonding surface 222 on the front side of the power substrate 200 as surface enhancement features that may enhance and die attach strength to the power substrate 200.

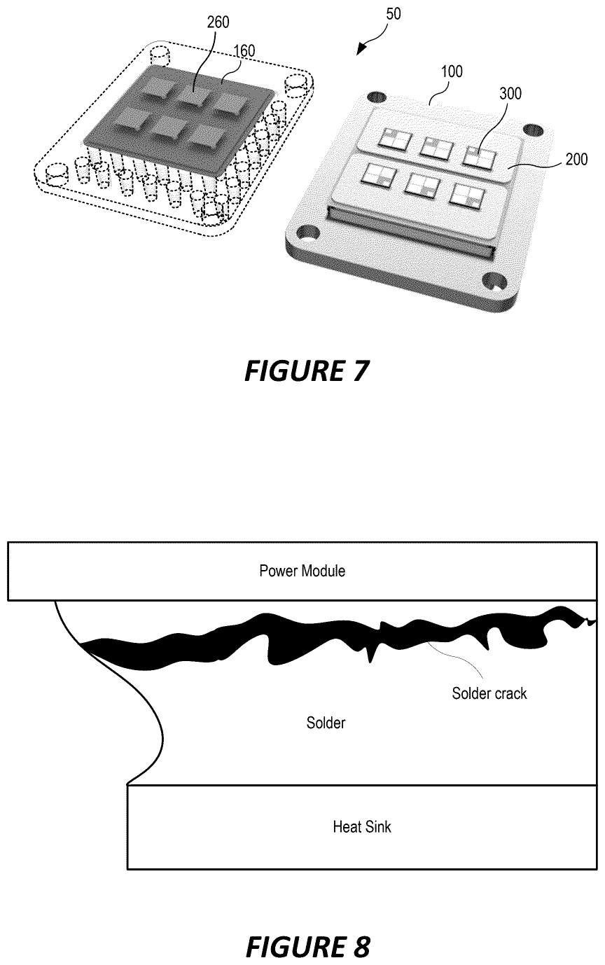

FIG. 7 illustrates an assembly 50 including a heat sink 100, power substrate 200, and power devices 300. The power substrate 200 is attached to the heat sink 100 via a first attach 160, while the power devices 300 are attached to the power substrate 200 via respective device attaches 260. The first and second attaches 160, 260 may be metallurgical attaches, for example, solder, braze, transient liquid phase bonding, sintering, and the like. The first and second attaches 160, 260 are shown separately in FIG. 7 from the heat sink 100, power substrate 200 and devices 300 for clarity of illustration. As seen in FIG. 7, due to the presence of surface enhancement features in the bonding surfaces of the heat sink 100 and power substrate 200, the first and second attaches display thickness variations near corners and/or edges thereof.

That is, some embodiments may provide modification of faying metal surfaces by means of surface enhancement features that result in thickness variations of the attach material, which may enhance metallurgical attach strength, robustness, and/or reliability of the structure.

In some embodiments, the surface enhancement features may be provided in selective locations and/or patterns on a bonding surface of a component such as a substrate or heat sink in high stress areas, for example, corners, edges, transitions, and the like.

In some embodiments, the surface enhancement features may be provided in selective locations and/or patterns in thermally insignificant areas of the component, for example, corners, edges, transitions, and the like.

Some embodiments use trenches or protrusions as surface enhancement features to increase surface area and/or bond line thickness in selective areas. Trenches or protrusions may also function as a strengthening mechanical anchor and/or to relieve thermal and mechanical stress in selective areas

Exemplary geometries of surface enhancement features provide trenches or protrusions that follow the perimeter of a bond profile, in the corners of a bond profile, and/or in arbitrary high stress locations.

Exemplary patterns of trenches or protrusions include linear, curved, elliptical, and polygonal elements according to various embodiments.

Some embodiments provide combinations of trenches or protrusions to form a composite solution of perimeter, corner, and/or arbitrary geometries.

The provision of trenches or protrusions on bonding surfaces according to some embodiments may increase surface area in selective areas. This may inhibit crack growth in selective areas and/or function as a strengthening mechanical anchor in selective areas by relieving thermal and mechanical stress in selective areas of a bonding surface.

During assembly and operation, there are many stresses experienced in the attach regions of semiconductor device packages, components and modules. Such stresses may arise from Coefficient of Thermal Expansion (CTE) mismatches in the structure resulting in thermal stress. Additional stresses may arise from external mechanical factors, for example, shock and vibration. In many cases, this stress is sufficient to surpass the yield or fatigue limit of some attach materials, causing degradation and ultimately failure within the attach layer.

An example schematic cross section of a failed package attach is shown in FIG. 8. As shown in FIG. 8, thermal stresses can cause a crack at the perimeter to rapidly propagate throughout the package attach layer. The presence of such a crack in the solder can cause the thermal resistance and/or the operating temperature of the device to increase.

Effective attaches deliver efficient heat transfer and strong mechanical robustness. They function as an intermediary mechanical and thermal interface between the component being attached and to what it is attached. There are conflicting goals of this interface. Thicker bond lines (i.e., thicker attach layers) tend to be more mechanically robust. However, thinner bond lines may provide better thermal performance. Striking the proper balance of material, surface, bond line thickness, and thermal performance often requires compromises.

Some embodiments described herein may achieve a robust bond line without sacrificing thermal performance or requiring more expensive, more exotic attach materials. To this end, some embodiments provide modifications of the mating surfaces to selectively modulate the thickness of the bond line. These intentionally structured surfaces result in a variable bond line thickness, where local zones are thicker in regions of higher stress and thinner in regions of peak heat transfer. They may also increase the bonded surface area in those regions to further increase bond strength.

Some embodiments described herein aim to reduce thermal stress and/or strain in an attach layer by introducing various patterned designs for trenches or protrusions in the bonding interface. These features serve as localized sites that may (1) strengthen the bond through anchoring, (2) selectively increase bond line thickness only where that is needed, and/or (3) act to inhibit or redirect crack growth away from critical areas. The specific dimensions and geometry of the features may vary based on the design of the mating surface, the type and format of component being attached, and the materials used in the assembly. In general, the dimensions and geometries will be placed in areas where (1) the stress is the highest and (2) the thermal effects of a localized change in the bond line will be insignificant.

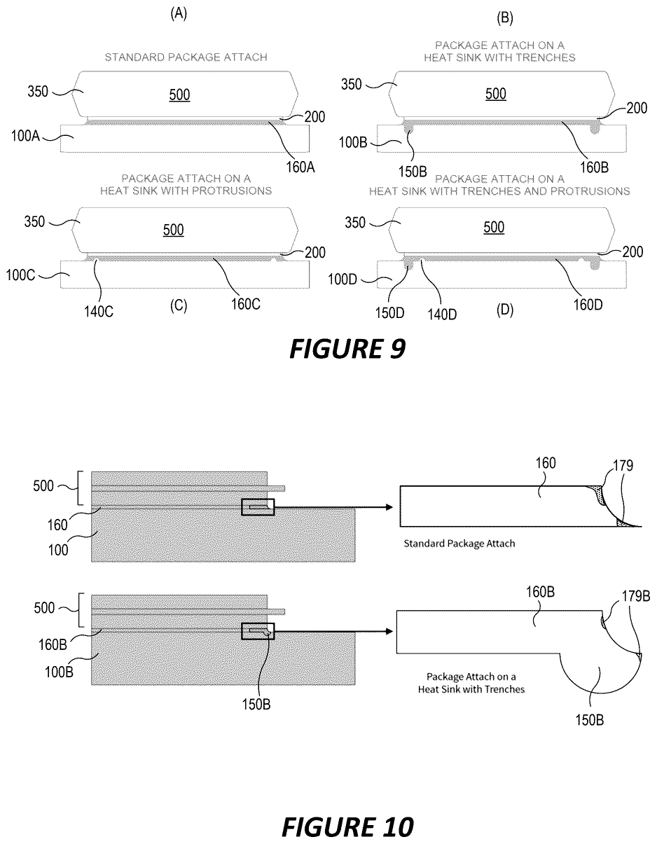

In some embodiments, the geometry of the feature may be designed or selected based on the stress gradient observed in the attach layer. FIG. 9 illustrates examples of various package attaches with protrusions and/or trenches provided in the bonding surface of the underlying heat sink. In the case of a power module being attached to a heat sink. It may be assumed that stress is highest along the edges of the package.

FIG. 9 (A) illustrates a standard package attach of a power semiconductor module 500 including a substrate 200 and a housing 350 to a heat sink 100A via a package attach 160A. No surface enhancement features are provided in the bonding surface of the heat sink 100A. Thus, the bond line of the package attach 160A has a constant thickness across the entire interface between the module 500 and the heat sink 100A.

Three modifications to a ‘standard’ surface are depicted in FIG. 9 (B) to 9 (D). In particular, FIG. 9 (B) illustrates a package attach in which material has been removed from the heat sink 100B to form a trench 150B along the perimeter of the interface between the module 500 and the heat sink 100B. The presence of the trench 150B locally increases the bond line thickness of the attach 160B, which adds an anchoring effect to increase the mechanical stability of the connection between the module 500 and the heat sink 100B.

FIG. 9 (C) illustrates a package attach in which material has been added to the heat sink 100C to form a protrusion 140C along the perimeter of the interface between the module 500 and the heat sink 100C. The presence of the protrusion 140C locally decreases the bond line thickness of the attach 160B, which adds an anchoring effect to increase the mechanical stability of the connection between the module 500 and the heat sink 100B. The presence of the protrusion 140C may also act to limit crack growth.

FIG. 9 (D) illustrates a package attach in which material has been added to the heat sink 100D to form a protrusion 140D along the perimeter of the interface between the module 500 and the heat sink 100D, and material has been removed from the heat sink 100D to form a trench 150D along the perimeter of the interface between the module 500 and the heat sink 100B. The presence of the protrusion 140D locally decreases the bond line thickness of the attach 160D, while presence of the trench 150D locally increases the bond line thickness of the attach 160D. This combination of both a trench and a protrusion may add an anchoring effect to increase the mechanical stability of the connection between the module 500, while also acting to limit crack growth.

As an example of the effectiveness of this method, FIG. 10 depicts a thermal stress simulation comparing a standard attach (top) to an attach where the bond line is selectively increased according to some embodiments (bottom).

In particular, FIG. 10 illustrates a power module 500 attached to a standard heat sink 100 via an attach 160 (top), and a power module 500 attached to a heat sink 100B in which a trench 150B is formed near the edge of the attach region defined by the interface between the module 500 and the heat sink 100B (i.e. near the edge of the module 500 when the module 500 is mounted on the heat sink 100B). Simulated stress gradients for each structure are shown on the right.

As seen in FIG. 10, in the structure with standard bonding surfaces (top), stress gradients are formed in the attach 160. Relatively large regions 179 of high stress are formed near the edges of the attach 160 and at the transition from the package attach fillet to the substrate surface. In contrast, in the structure in which a surface enhancement feature, namely trench 150B, is formed near the edge of the attach region, the stress gradients are substantially smaller, with only small regions 179B of high stress being formed. By determining the location of expected stresses and selectively increasing the bond line thickness in those regions, the magnitude of the stress can be reduced and/or the distribution of stresses can be smoothed out. This may significantly improve the mechanical stability and/or robustness of the attach.

Note that the type and format of substrate, package, power module, device, terminal, and the like may vary greatly, so a suite of possible implementations can be conceived to account for such a large variation of potential solutions. Many such options are described below.

Surface enhancement features may be provided in any of the surfaces to be joined in a power module. Most commonly, they could be in the heat sink and/or power substrate metallization layers. However, enhancements to any of the faying surfaces are possible and are contemplated within the scope of this disclosure.

For most metal or metallized surfaces, the structures could be formed through a variety of methods, including machining, casting, progressive stamping, forging, metal injection molding, selective etching, step etching, lasering, water jet cutting, embossing, debossing, 3D printing, and any similar metal formation methods. Material could also be added through deposition processes, for example, plating, welding, flame spray, cold spray, vacuum deposition, and similar methods of depositing metal onto a surface.

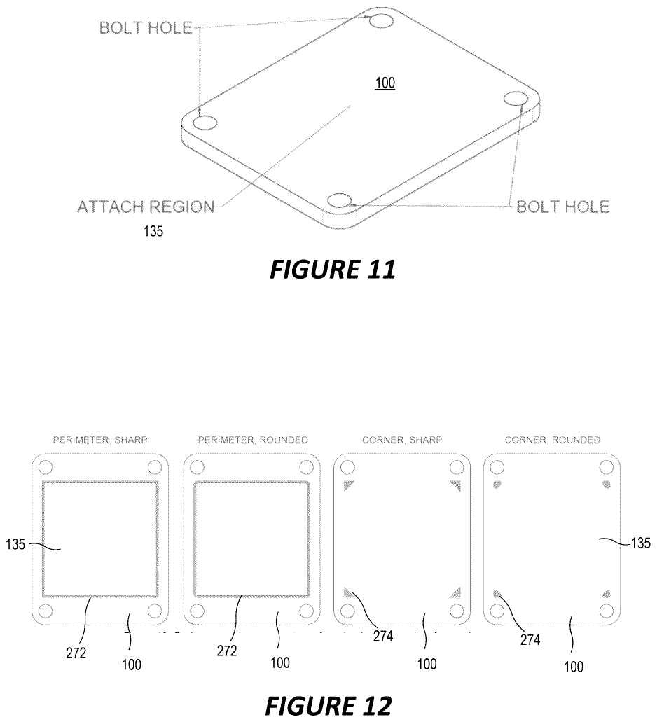

For the purposes of description, embodiments and example patterns are depicted on a simplified heat sink 100 with no surface enhancement features as shown in FIG. 11. The example heat sink 100 has a mounting surface including an attach region 135 on which a component is to be mounted by means of a metallurgical attach. Although described and illustrated below in connection with a heat sink, it will be appreciated that the surface enhancement features described herein could be applied to attachable surface that is to be bonded metallurgically, including substrates, base plates, and any other mounting surface within a power semiconductor package, device or module.

The patterns, as indicated in the following depictions, could be either added material (protrusions), removed material (trenches), or a combination of both. As previously described, these geometries may be located in areas of highest stress, and preferably in places where modifying the surfaces would have an insignificant impact on thermal performance. Specific details such as width of features, depth of features, and the like will vary based on specific implementations and can be considered arbitrary for the sake of the descriptive examples presented herein.

The simplest and most direct embodiments are corner and perimeter patterns, as most of the time stresses are highest at the point of transition, which tend to be corners and edges of the bonding region 135. These may have sharp or rounded internal corners, as indicated in FIG. 12, which illustrates perimeter patterns 272 and corner patterns 274 for raised or lowered surface enhancement features. The internal corners may have other shapes, for example, polygonal, irregular/organic or any other suitable transition.

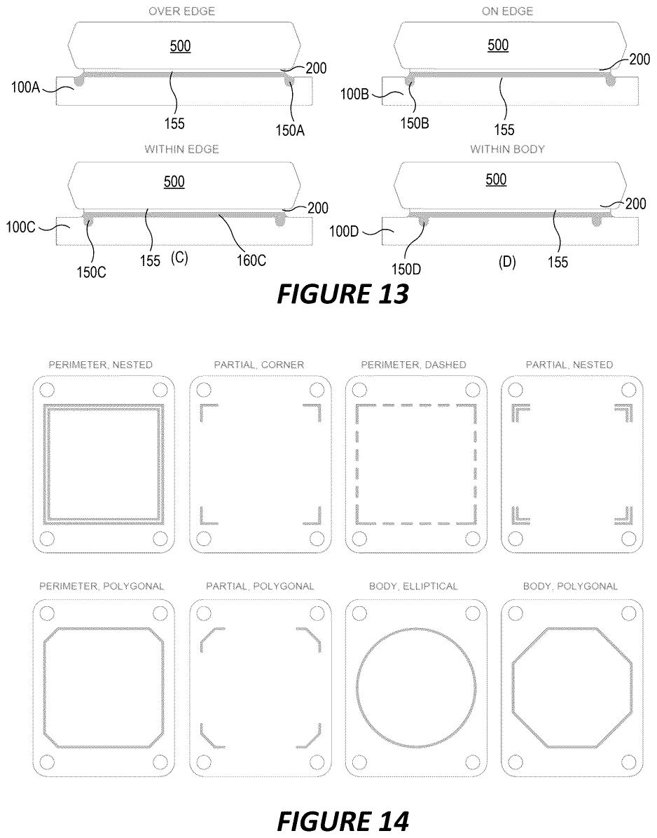

The surface enhancement features may be located within, on-edge, or over the edge of the component being attached. The location may depend on the stress pattern based on the material and geometrical specifics of a given solution. In various embodiments, the patterns could be considered to be located as indicated in FIG. 13, showing the attach bond line for various locations of a trench surface enhancement feature. Although illustrated in connection with trench surface enhancement features, the embodiments shown in FIG. 13 also apply to raised surface enhancement features and compound surface enhancement features including both raised and lowered features.

For example, as shown in FIG. 13 (A), the trench surface enhancement feature 150A (a trench in this example) may be located over or just outside the edge of the mounting footprint 155, where the “mounting footprint” refers to the area where the mounted element (in this example, the substrate 200 of a power module 500) contacts the mounting surface of the element on which the mounted element is mounted (in this example, the upper surface of the heat sink 100A).

In some embodiments as shown in FIG. 13 (B), the trench surface enhancement feature 150B may be located on or straddling the edge of the mounting footprint 155.

In some embodiments as shown in FIG. 13 (C), the trench surface enhancement feature 150C may be located within the perimeter of the mounting footprint 155 and adjacent to the edge of the mounting footprint 155.

In some embodiments as shown in FIG. 13 (D), the trench surface enhancement feature 150D may be located within the perimeter of the mounting footprint 155 and spaced apart laterally from the edge of the mounting footprint 155.

Many stress-profile based embodiments are conceived based on combinations of simple geometric shapes and combinations of perimeter, corner, and body features. The patterns can be categorized as follows: (1) line, (2) dot, (3) regular geometry, (4) pattern, (5) fill, (6) organic, and (7) composite.

Exemplary patterns for line based geometries are illustrated in FIG. 14 showing a variety of design aspects. Note that these depictions are descriptive in nature and specific implementation will vary based on the particular stress profile and fabrication method of a particular design. As depicted, lines can be single or nested (two are shown in two depictions for simplicity but multiple lines are possible over any of the shapes). The lines may be a closed profile or partial segments. Transitions between lines may be square, rounded, polygonal, or similar geometry. Other combinations of these various patterns are possible.

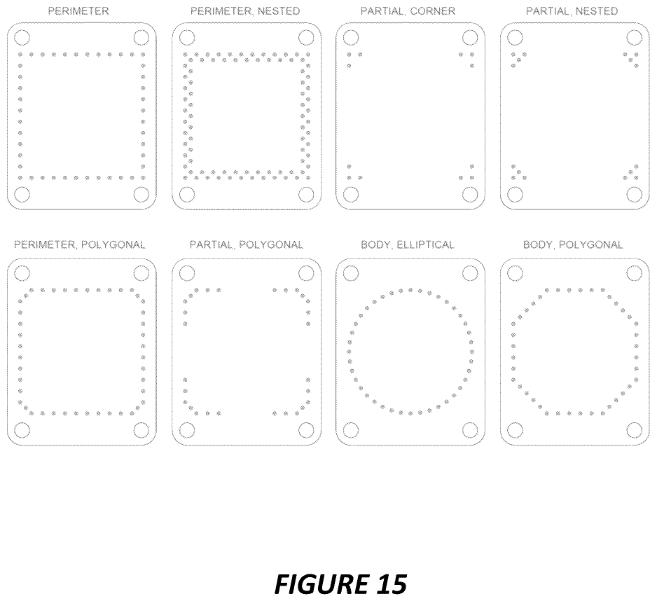

Exemplary patterns for dot based geometries are illustrated in FIG. 15 showing a variety of design aspects. Note that these depictions are descriptive in nature and specific implementation will vary based on the particular stress profile and fabrication method of a particular design. As depicted, dots can be single or nested (two are shown in two depictions for simplicity but multiple lines are possible over any of the shapes). The dots may be circular, polygonal, similar geometric, or organic/asymmetric element depending on fabrication method. The dots may be arranged along the perimeter of the bonding area, in corners, in a polygonal shape, etc. Other combinations are possible depending on design requirements.

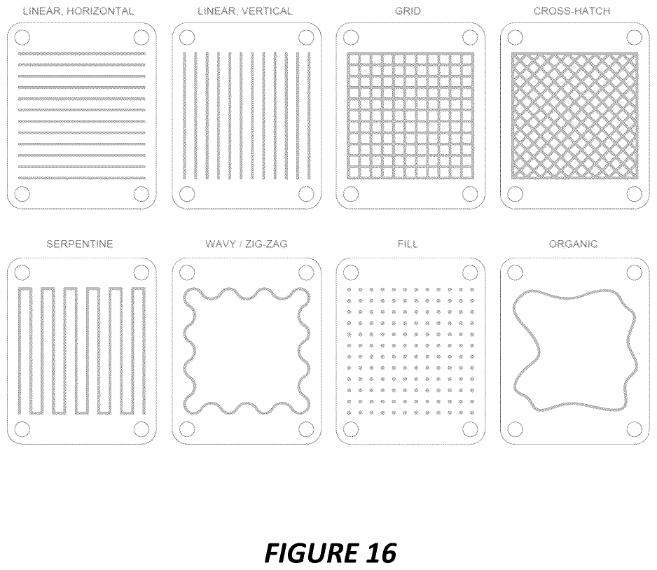

Exemplary patterns for regular, fill, and organic based geometries are illustrated in FIG. 16 showing a variety of design aspects. Note that these depictions are descriptive in nature and specific implementation will vary based on the particular stress profile and fabrication method of a particular design. Transitions between lines may be square, rounded, polygonal, or similar geometry. Other shapes are also possible. For fill patterns, the shape may be circular, polygonal, or similar geometric element depending on fabrication method. Other possible shapes of the surface enhancement features include linear, grid, cross-hatch, serpentine, wavy, fill and asymmetric or organic.

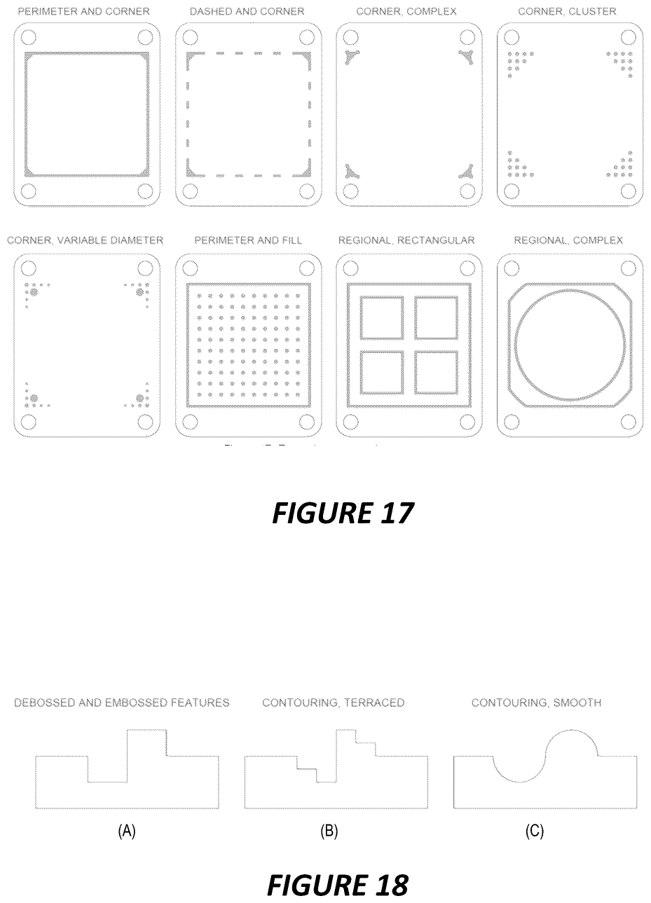

For more complex stress distributions, composite patterns can be utilized which are combinations and variations of multiple approaches. Examples are illustrated in FIG. 17, and include combinations of perimeter and corner features, dashed perimeter and corner features, complex corner features, clustered corner features, variable diameter corner features, rectangular features and nested features. Note that these depictions are descriptive in nature and specific implementation will vary based on the particular stress profile and fabrication method of a particular design. Transitions between lines may be square, rounded, polygonal, or similar geometry. Some combinations of these various patterns are possible in some embodiments not depicted. For fill patterns, the shape may be circular, polygonal, or similar geometric or organic element depending on fabrication method.

For the patterns described, it is possible that using both trench and protrusion features on the same surface would be of benefit. In some cases, multiple depths or heights of these features could also be employed. Conforming surfaces such as this one thickens the bond line thickness of the solder in critical regions where higher thermal stresses are found and lowers the bond line thickness in regions where lower thermal stresses are found. This increases the strength of the solder joint with low or minimal effect on the thermal resistance of the unit. Conforming surfaces could also be used if the component being attached has a high amount of warpage or surface variation. A section view detailing the various contoured surfaces is depicted in FIG. 18. For example, the transition between adjacent trenches and protrusions can be made as discrete steps as shown in FIG. 18 (A), terraced or contoured steps as shown in FIG. 18 (B), or smoothly contoured as shown in FIG. 18 (C). Note that the number of terraced layers and shape of smooth features can vary based on need and manufacturing processes.

The conventional approach to joining surfaces in power modules (heat sink, substrate, device, terminal, and the like) consists of soldering or similar metallurgical attaches to flat or slightly bowed surfaces with minimal variation in the surfaces. To increase reliability and robustness of the joint, one would be required to use a stronger alloy, change to materials with a better CTE match, or increase the thickness of an attach joint. All of which come with difficult tradeoffs in performance, complexity, and cost.

Using a stronger solder alloy is widely recognized as a solution to strengthen the joint. However, this often requires higher reflow temperatures as the liquidus temperature of stronger alloys is typically higher. In addition, many robust alloys contain lead or other undesirable elements which limit the use of products which require them. Higher reflow temperatures cause more internal damage to the power module during attach processing. This internal damage can manifest as mold compound delamination, dielectric cracking, damage to other attaches, and can negatively affect a power module's performance and reliability.

Optimizing testing and application conditions is another method that can be used to reduce stress in the solder joint. This can be done in the form of pin fin design, coolant flow rate, coolant temperature, or current run through the power module. Even after optimizing all these conditions, it is possible that there is still too much stress in the solder joint to avoid delamination in reliability testing.

The design of the heatsink, substrate, etc. may result in lower stresses in the solder joint. These design manipulations typically come in the form of pedestal dimensions, material, pin fin design, or dimensions.

The surface modifications described herein add an additional form of design manipulation with a goal of reducing stress and adding mechanical robustness in the solder joint.

Increasing the thickness of a package solder joint may increase the area moment of inertia of the solder joint, making it more resistant to bending stress resulting from thermal stress. The challenge associated with increasing thickness is there is an increased chance of voids within the solder joint that would negatively impact thermal performance of the power module. Additionally, the increased thickness may increase the thermal resistance of the power module when applied in a system. This may require less current to be run through the power module to ensure the devices remain within their operating temperatures.

Some embodiments described herein may be created according to a design method that aims to reduce the stress within the attach joint locally at areas of highest concentration by including features on the heatsink solder bond interface. This may avoid increasing the overall solder thickness and possibly avoid the requirement of stronger alloys depending on the application of the power module. This may allow for strong thermal performance and help to ensure the module is functional after package attach due to less epoxy molded compound (EMC) delamination.

Many possible embodiments are described herein which could be implemented in response to the unique stress distribution and concentration of a given power module internal and external structure.

Specifically, the following embodiments are described herein, which may be either sunken (debossed), raised (embossed), or contoured features.
Closed loop patterns of linear, curved, elliptical, and polygonal elements, single line and/or nested;
Corner patterns of linear, curved, elliptical, and polygonal elements, single line and/or nested;
Partial dashed patterns of linear, curved, elliptical, and polygonal elements, single line and/or nested;
Dot Patterns of Circular And/or Polygonal Arrays;
Linear arrays of linear, diagonal, curved, serpentine linear, elliptical, and/or polygonal elements;
Fill patterns of circular and/or polygonal arrays;
Organic patterns of irregular elements;
Composite patterns combining some or part of the outlined approaches.

Because the surface modification features may reduce the stress and strain within an attach layer, some embodiments described herein can be applied to various forms of attach such as metallurgic attaches (solder, braze, transient liquid phase bonding, sintering, and the like). Additionally, various embodiments described herein can be applied into various forms of attach, including package attach, substrate attach, device attach, terminal attach, and the like.

As power modules continue to be developed, larger area packages will be required to dissipate the heat generated from the power module. Large area packages will require novel methods of reducing stress within the attach layer. As these demands increase, this method of attachment serves as a key stress reduction method which can be implemented in future heat sink design.

A methodology for selecting the design and/or location of surface enhancement features according to some embodiments will now be described.

In general, the location, pattern, and dimensions of the surface modifications may be designed using the following procedure.
[1] Identify the stress scenario under which the product will experience under typical operation or qualification requirements (service conditions, system testing conditions, power cycling, thermal cycling, thermal shock, etc.).
[2] Create a Computer Aided Design (CAD)/Finite Element Analysis (FEA) thermal stress simulation model with an accurate representation of the attach layers and all geometries being attached.
[3] Simulate under the most relevant condition(s) as defined in [1].
[4] Modify the bonded surfaces in the CAD model based on the stress patterns extracted by adding or removing surface material such that the attach layer conforms to those shapes after metallurgical bonding.
[5] Validate updated CAD model by running a simulation and comparing it to the baseline.
[6] Repeat steps [4] and [5] until a desirable stress response is achieved. This is often achieved through parametric sweeps with multi-variable goal seeking optimization algorithms.
[7] Select the most optimal geometric configuration.
[8] [Optional] Validate simulation results with physical testing.

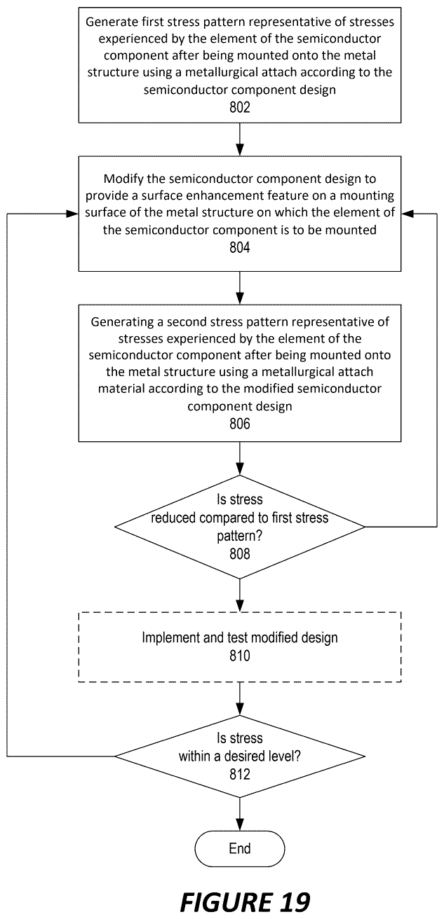

Accordingly, referring to FIG. 19, some embodiments provide a method of manufacturing a semiconductor component. For a semiconductor component design comprising a metal structure and an element of the semiconductor component mounted on the metal structure, the method includes generating a first stress pattern representative of stresses experienced by the element of the semiconductor component after being mounted onto the metal structure using a metallurgical attach material according to the semiconductor component design (block 802).

The semiconductor component design is modified to provide a surface enhancement feature on a mounting surface of the metal structure on which the element of the semiconductor component is to be mounted (block 804).

A second stress pattern is then generated representative of stresses experienced by the element of the semiconductor component after being mounted onto the metal structure using a metallurgical attach material according to the modified semiconductor component design (block 806).

The first stress pattern is then compared to the second stress pattern to determine if the stress in the semiconductor component is reduced (block 808). If not, operations return to block 804 and a new design is considered.

If the second stress pattern indicates that stress is reduced by the modified component design, the modified component design based may optionally be implemented (block 810), and the modified component design may be evaluated to determine if the stress is within an acceptable range (block 812), and if so, operations terminate. If the stress is not within an acceptable range, operations return to block 804 and a new modification is considered using the modified component design as the new starting point.

The inventive concepts have been described above with reference to the accompanying drawings, in which embodiments of the inventive concepts are shown. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout, except where expressly noted.

It will be understood that although the terms first and second are used herein to describe various regions, layers and/or elements, these regions, layers and/or elements should not be limited by these terms. These terms are only used to distinguish one region, layer or element from another region, layer or element. Thus, a first region, layer or element discussed below could be termed a second region, layer or element, and similarly, a second region, layer or element may be termed a first region, layer or element without departing from the scope of the present inventive concepts.

Relative terms, such as “lower” or “bottom” and “upper” or “top,” may be used herein to describe one element's relationship to another element as illustrated in the drawings. It will be understood that relative terms are intended to encompass different orientations of the device in addition to the orientation depicted in the drawings. For example, if the device in the drawings is turned over, elements described as being on the “lower” side of other elements would then be oriented on “upper” sides of the other elements. The exemplary term “lower” can, therefore, encompass both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, elements, and/or components, but do not preclude the presence or addition of one or more other features, elements, components, and/or groups thereof.

Embodiments of the inventive concepts are described herein with reference to cross-sectional illustrations that are schematic illustrations. As such, variations from the shapes of the illustrations as a result, for example, of manufacturing techniques and/or tolerances, are to be expected. Thus, embodiments of the inventive concepts should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Thus, the regions illustrated in the figures are schematic in nature and their shapes are not intended to illustrate the actual shape of a region of a device and are not intended to limit the scope of the inventive concepts.

It will be understood that the embodiments disclosed herein can be combined. Thus, features that are pictured and/or described with respect to a first embodiment may likewise be included in a second embodiment, and vice versa.

While the above embodiments are described with reference to particular figures, it is to be understood that some embodiments of the present inventive concepts may include additional and/or intervening layers, structures, or elements, and/or particular layers, structures, or elements may be deleted. Although a few exemplary embodiments of the inventive concepts have been described, those skilled in the art will readily appreciate that many modifications are possible in the exemplary embodiments without materially departing from the novel teachings and advantages of the inventive concepts. Accordingly, all such modifications are intended to be included within the scope of the inventive concepts as defined in the claims. Therefore, it is to be understood that the foregoing is illustrative of the present inventive concepts and is not to be construed as limited to the specific embodiments disclosed, and that modifications to the disclosed embodiments, as well as other embodiments, are intended to be included within the scope of the appended claims. The inventive concepts are defined by the following claims, with equivalents of the claims to be included therein.

1. A semiconductor component, comprising:
a support structure;
an element of the semiconductor component on the support structure; and
a metallurgical attach material that attaches the element of the semiconductor component to the support structure;
wherein the support structure comprises a mounting surface for receiving the element of the semiconductor component, wherein the element of the semiconductor component is mountable within a mounting region of the mounting surface; and
wherein the mounting surface comprises a surface enhancement feature that is configured to modify a thickness of the metallurgical attach material that is provided in or near the mounting region between the support structure and the element of the semiconductor component to attach the element of the semiconductor component to the support structure.

2. The semiconductor component of claim 1, wherein the surface enhancement feature is a three-dimensional feature.

3. The semiconductor component of claim 1, wherein the surface enhancement feature comprises a trench.

4. The semiconductor component of claim 1, wherein the surface enhancement feature comprises a protrusion.

5. The semiconductor component of claim 4, wherein the surface enhancement feature comprises an elongated protrusion.

6. The semiconductor component of claim 1, wherein the surface enhancement feature comprises a hole.

7. The semiconductor component of claim 1, wherein a thickness of the attach material is greater near corners of the mounted element than away from corners of the mounted element.

8. The semiconductor component of claim 1, wherein the surface enhancement feature is provided within a mounting footprint of the mounted element.

9. The semiconductor component of claim 1, wherein the surface enhancement feature overlaps an edge of a mounting footprint of the mounted element and/ wherein the surface enhancement feature is provided outside a mounting footprint of the mounted element.

10. The semiconductor component of claim 1, wherein the surface enhancement feature is provided near corners of a mounting footprint of the mounted element.

11-12. (canceled)

13. The semiconductor component of claim 1, wherein the surface enhancement feature forms a polygonal, elliptical or circular shape on the mounting surface, or forms a pattern of linear features on the mounting surface, or forms a grid, cross-hatch, serpentine, wavy, fill, or random pattern on the mounting surface.

14. The semiconductor component of claim 1, wherein the surface enhancement feature is formed near a portion of a mounting footprint of the mounted element where the element of the semiconductor component is expected to experience heightened stress after mounting.

15. The semiconductor component of claim 1, wherein the support structure comprises a submount, heatsink, power substrate, and/or a base plate and wherein the element of the semiconductor component comprises a semiconductor die, a submount, or a power substrate.

16. (canceled)

17. The semiconductor component of claim 1, wherein the surface enhancement feature comprises multiple surface enhancement features arranged in concentric patterns.

18. The semiconductor component of claim 1, wherein the element of the structure comprises a semiconductor die and wherein the support structure comprises a power substrate.

19. The semiconductor component of claim 18, wherein the power substrate is mounted on an underlying support structure, wherein the underlying support structure comprises a second mounting surface for receiving the support structure, wherein the support structure is mountable within a second mounting region of the second mounting surface; and
wherein the second mounting surface comprises a second surface enhancement feature that is configured to modify a thickness of a second metallurgical attach material that is provided in or near the second mounting region between the underlying support structure and the support structure to attach the support structure to the underlying support structure.

20. The semiconductor component of claim 18, wherein the underlying support structure comprises a heat sink.

21. A support structure for mounting an element of a semiconductor component, wherein the support structure comprises:
a mounting surface for receiving the element of the semiconductor component, wherein the element of the semiconductor component is mountable within a mounting footprint of the mounting surface;
wherein the mounting surface comprises a surface enhancement feature that is configured to modify a thickness of a metallurgical attach material that is provided between the support structure and the element of the semiconductor component to attach the element of the semiconductor component to the support structure.

22-35. (canceled)

36. A method of manufacturing a semiconductor component, comprising:
(a) for a semiconductor component design comprising a support structure and an element of the semiconductor component mounted on the support structure, generating a first stress pattern representative of stresses experienced by the element of the semiconductor component after being mounted onto the support structure using a metallurgical attach material according to the semiconductor component design;
(b) modifying the semiconductor component design to provide a surface enhancement feature on a mounting surface of the support structure on which the element of the semiconductor component is to be mounted;
(c) generating a second stress pattern representative of stresses experienced by the element of the semiconductor component after being mounted onto the support structure using a metallurgical attach material according to the modified semiconductor component design;
(d) comparing the first stress pattern to the second stress pattern; and
(e) implementing the modified semiconductor component design based on the comparison of the first stress pattern and the second stress pattern.

37. The method of claim 36, further comprising:
repeating steps (b) through (e) until a desired level of stress in the element of the semiconductor component is obtained.

38-44. (canceled)
